(19) United States
(12) Patent Application Publication
(10) Pub. No.: US 2007/0198953 A1
(43) Pub. Date: Aug. 23, 2007

(54) Target acquisition

(75) Inventors: Patrick Markus Baudisch, Seattle, WA (US); Adam Eversole, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/360,016

(22) Filed: Feb. 22, 2006

(51) Int. Cl. G06F 9/00

(52) U.S. Cl. 715/856; 715/857; 715/862

(57) ABSTRACT

The present invention is directed at making a computer interface easier to use by facilitating the acquisition of a target with a pointer. In this regard, normal pointer movement is altered, when the pointer is scheduled to intersect an adjustment barrier associated with a target. The pointer movement is altered at the adjustment barrier to assist the user in keeping the pointer located on the target. Moreover, while the pointer is located on the target, the user may cause a pointer selection event to occur. Alternatively, the user may generate input for the purpose of “breaking free” from a threshold distance where pointer movement is adjusted.

### BACKGROUND

A significant number of computers (e.g., personal computers, tablet computers, personal digital assistants (“PDAs”), cellular telephones, and the like) employ a graphical user interface (hereinafter “GUI”) to interact with users. Those skilled in the art will recognize that a GUI is an input/output (“I/O”) system characterized by the use of graphics on a computer display to communicate with a computer user. In some types of computers, the user employs an indirect input device, such as a mouse or trackball to manipulate and relocate a pointer on the computer display and generate commands. In other types of computers, a user employs a direct input device, such as a handheld pen, stylus, and the like, to directly interact with the computer display. In either instance, the user may activate the pointer at a designated position on the computer display to generate a pointer selection event using the input device. For example, a computer user with an indirect input device typically “double-clicks” a button on the input device to generate a pointer selection event. Similarly, a computer user with a direct input device may generate a pointer selection event, for example, by “double tapping” on the computer display. In either instance, the pointer selection event typically issues a command that requires the computer to perform an action. Accordingly, a user does not need to have knowledge of keyboard typing to provide input to the computer.

A GUI generally presents graphical display elements (hereinafter “GUI objects”) as two-dimensional images composed of pixels on a computer display. The pointer is a GUI object that is presented as overlaying all other GUI objects. One coordinate on a pointer is a “hot spot” that identifies a specific location (i.e., coordinate position on the computer display) where a pointer selection event may be generated. However, in order for a pointer selection event to occur, the pointer's “hot spot” must be located on a target. A computer operating system or program may be configured to display multiple targets on a computer display. For example, GUI objects commonly known as icons are typically displayed by an operating system on a computer “desktop.” When the pointer acquires an icon and a pointer selection event is generated, execution of a computer program that is represented by the icon is initiated. Moreover, a computer program may also display targets to a user. For example, resize handles are targets that allow users to change the size of a Window by causing a pointer selection event to occur on the resize handle. When a pointer selection event occurs while the “hot spot” of the pointer is on the resize handle, the area occupied by the window is changed.

Positioning the “hot spot” of a pointer over a desired target, such as a resize handle, is often difficult to accomplish, leading to frustration and lowered productivity. In some instances, users with diminished visual or physical abilities, or lack of training have difficulty in positioning a pointer. In other instances, pointer positioning difficulty may be attributable to the computer. For example, a computer display may provide a high-density presentation of material, rendering targets relatively small and making precise pointer positioning difficult.

An inability to place the hot spot of a pointer on a specific target creates problems because the desired function may not easily be performed. Instead, the user may need to repetitively readjust a pointer to perform the desired function. Thus, acquisition aids have been developed to assist users in acquiring a target with the pointer. For example, a description of one type of target acquisition aid is provided in commonly assigned, co-pending U.S. patent application Ser. No. 10/829,127 entitled “System and Method for Acquiring a Target With Intelligent Pointer Movement.” In this example, the motor space allocated to a target is enlarged so that a proportionally larger amount of movement from an input device is required to move the pointer across the target. As a result, from the user's perspective, a target feels “sticky” in that removing the pointer from the target will not occur when small and/or inadvertent input device movement occurs. However, this type of acquisition aid is most appropriate when a computer employs an indirect input device, such as a mouse or a trackball to relocate the pointer.

Enlarging the motor space of a target when a computer employs a direct input device may have effects that would not be expected by the user. For example, if a direct input device encountered an enlarged motor space target, the location where the input device contacts the computer display would separate from the location where the pointer is represented. Since a direct correlation generally exists between a direct input device and a pointer, this type of disconnection may not be expected by a user. Moreover, as a result of the disconnection between input device and pointer movement, the user would be unable to use the input device to move the pointer to every location on the computer display. Instead, at least some area of the computer display would become inaccessible.

While specific disadvantages of existing systems have been illustrated and described in this Background Section, those skilled in the art and others will recognize that the subject matter claimed herein is not limited to any specific implementation for solving any or all of the described disadvantages.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The foregoing problems discussed in the Background Section above are overcome by the present invention, embodiments of which are directed at making a computer easier to use. More specifically, in one embodiment, a method is provided that facilitates the acquisition of a target with a pointer. In this regard, the method alters normal pointer movement, when the pointer is scheduled to intersect an adjustment barrier associated with a target. The pointer movement is altered at the adjustment barrier to assist the user in keeping the pointer located on the target. Moreover, while the pointer is located on the target, the user may cause a pointer selection event to occur for the purpose of issuing a command. Alternatively, the user may generate input for the purpose of “breaking free” from a location where pointer movement is adjusted. In this regard, if the projected movement of the pointer exceeds a predetermined threshold distance from the location where the pointer intersected the adjustment barrier, pointer movement is no longer altered by aspects of the present invention.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of the computer that includes components suitable for adjusting pointer movement in order to make a computer easier to use;

FIG. 2 is a pictorial depiction of a section of computer display that illustrates how pointer movement may be adjusted in order to make a computer easier to use;

FIG. 3 is a pictorial depiction of the section of the computer display depicted in FIG. 2 that may be used to illustrate aspects of the present invention when overlapping adjustment barriers are used to alter pointer movement;

FIG. 4 is a pictorial depiction of a slider that illustrates how pointer movement may be altered to align GUI objects in a one-dimensional context;

FIG. 5 is a pictorial depiction that may be used to describe how pointer movement may be altered to align GUI objects in a two-dimensional context; and

FIG. 6 is a flow diagram illustrating one exemplary embodiment of an adjustment routine that assists the user in acquiring a target that maintains an adjustment barrier.

### DETAILED DESCRIPTION

The present invention may be described in the general context of computer-executable instructions, such as program modules, being executed by a computer. Generally described, program modules include routines, programs, objects, components, data structures, and the like that perform particular tasks or implement particular abstract data types. The present invention may also be practiced in distributed computing environments where tasks are performed by remote processing devices that are linked through a communications network. In a distributed computing environment, program modules may be located on local and/or remote computer storage media.

Generally described, a method, software system, and computer-readable medium are provided for facilitating the acquisition of a target with a pointer. In one aspect, the present invention is directed to various methods for facilitating and/or maintaining the acquisition of a target with a pointer by adjusting pointer movement. In this regard, when an input device movement event is identified, a determination is made regarding whether the projected movement of the pointer intersects an adjustment barrier associated with a target. If an adjustment barrier is scheduled to be intersected, pointer movement is adjusted so that the pointer is displayed on an adjustment barrier. Moreover, while the projected movement of the pointer remains within a predetermined distance from the adjustment barrier, pointer movement continues to be adjusted so that acquisition of the target with the pointer is easy to maintain.

As known to those skilled in the art and others, a pointer is a GUI object that is displayed to a user as any one of a number of pictorial depictions. Generally described, aspects of the present invention may be implemented using any type of GUI object for a pointer that is capable of identifying a “hot spot” on a computer display. In accordance with one embodiment, pointer movement is adjusted to help users acquire a target with a pointer. A target as used herein may be any graphical object that is displayed to a user including, but not limited to, icons, resize handles, menu items, or any other pictorial depiction that has meaning in a computing environment. The following description first provides an overview of a system in which the present invention may be implemented. Then a method that adjusts pointer movement when input causes the pointer to intersect one or more adjustment barriers, which is illustrated in accompanying diagrams, is described. The illustrative examples described herein are not intended to be exhaustive or to limit the invention to the precise forms disclosed. Similarly, any steps described herein may be interchangeable with other steps, or several combinations of steps, in order to achieve the same result.

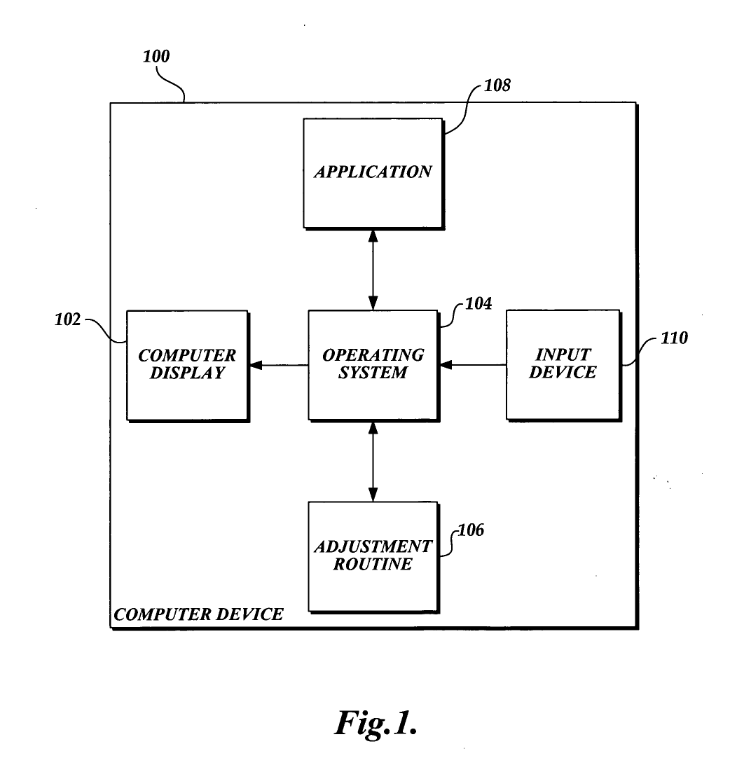

Now with reference to FIG. 1 an exemplary computer 100 in which embodiments of the present invention may be implemented will be described. As illustrated in FIG. 1, the exemplary computer 100 includes a computer display 102, an operating system 104, an adjustment routine 106, an application 108, and an input device 110. The computer 100 may be any one of a variety of devices including, but not limited to, personal computing devices, server-based computing devices, personal digital assistants (“PDAs”), cellular telephones, tablet computers, other electronic devices having some type of memory, and the like. For ease of illustration and because they are not important for an understanding of the present invention, FIG. 1 does not show some of the typical components of many computers, such as memory, a central processing unit, etc. Moreover, it should be well understood that aspects of the present invention are especially well-suited for implementation in a computer that uses a direct input device to relocate a pointer on a computer display. For example, tablet computers and PDAs frequently use a direct input device to relocate a pointer.

The operating system 104 illustrated in FIG. 1 may be a general-purpose operating system, such as a Microsoft® operating system, UNIX® operating system, or Linux® operating system. Moreover, the operating system 104 may be designed specifically for limited resource computing devices, such as a Palm® operating system, Windows® CE operating system, or any other operating system that employs a GUI to interact with the user. In any event, those skilled in the art and others will recognize that the operating system 104 controls the general operation of the computer 100 and is responsible for management of hardware and basic system operations, as well as executing programs. In this regard, the operating system 104 insures that computer programs, such as application 108, are able to use hardware resources of the computer 100.

The computer 100 illustrated in FIG. 1 is configured to execute computer programs, such as application 108, which causes GUI objects to be displayed on the computer display 102. Application 108 may be any computer program which causes GUI objects to be displayed including, but not limited to, editors, word processors, spreadsheets, browsers, computer-aided design, and the like. Those skilled in the art and others will recognize that the operating system 104 monitors input device events and provides a mechanism for the application 108 to perform actions in response to these events. For example, application 108 may be configured to communicate with the operating system 104 for the purpose of receiving notice of events that are generated by the input device 110. Since the operating system 104 manages hardware resources on the computer 100, the application 108 is not able to directly access data that is related to events generated by the input device 110. Instead, as illustrated in FIG. 1, the operating system 104 manages access to the input device 110 and communicates information to the application 108 when the application 108 needs to execute an event-driven routine.

As further illustrated in FIG. 1, the computer 100 includes a computer display 102, which may be typical display devices, such as a monitor (e.g., CRT or LCD screen), a television, etc. As illustrated in FIG. 1, the computer display 102 interacts with the operating system 104 for the purpose of displaying graphical objects to the user. As mentioned previously, aspects of the present invention are especially well-suited for a computer that uses a direct input device to relocate a pointer on a computer display. Thus, in one embodiment, the computer display 102 maintains a touch sensitive display surface coupled with a touch controller to track the location where the input device 110 contacts the touch sensitive display surface. However, those skilled in the art will recognize that the computer display 102 may be any device capable of displaying graphical objects to a user and the example provided above should be construed as exemplary and not limiting.

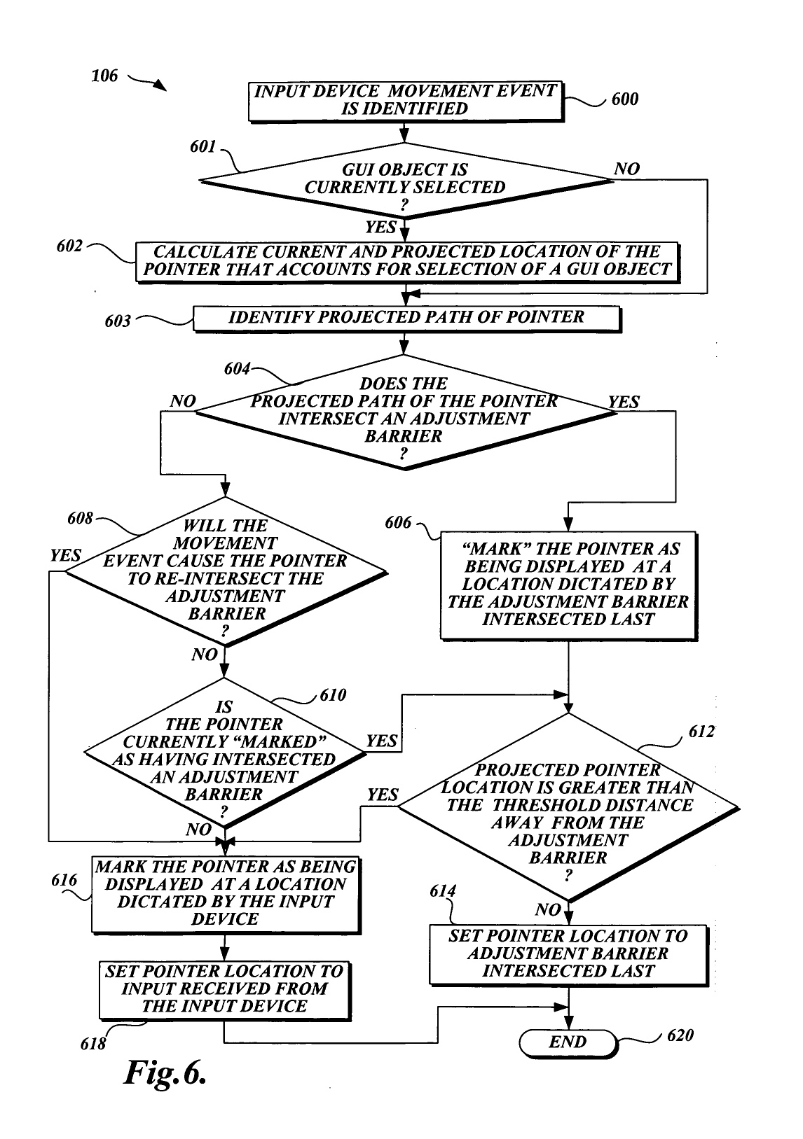

As will be better understood from the description provided below with reference to FIG. 6, some aspects of the present invention are implemented by a set of event-driven routines located in the adjustment routine 106. FIG. 1 shows that the adjustment routine 106 is interconnected and able to communicate with the operating system 104. Moreover, the operating system 104 notifies the adjustment routine 106 when the input device 110 generates one or more input device movement events. If the projected movement of the pointer intersects an adjustment barrier, aspects of the present invention adjust the normal pointer movement to make a target easier to acquire. In this regard, the operating system 100 may receive an adjusted coordinate position from the adjustment routine 106 and cause the computer display 102 to display the pointer at the adjusted coordinate position.

When software formed in accordance with the invention is implemented in a computer, for example of the type illustrated in FIG. 1, the computer provides a way for users to easily acquire a target. Allowing a user to easily acquire a target enhances the computer experience by making programs and/or an operating system easier to use. As known to those skilled in the art and others, FIG. 1 is a simplified example of one computer 100 capable of performing the functions of the present invention. However, actual embodiments of the computer 100 will have additional components not illustrated in FIG. 1 or described in the accompanying text. Moreover, FIG. 1 shows one component architecture for implementing the present invention but other component architectures are possible.

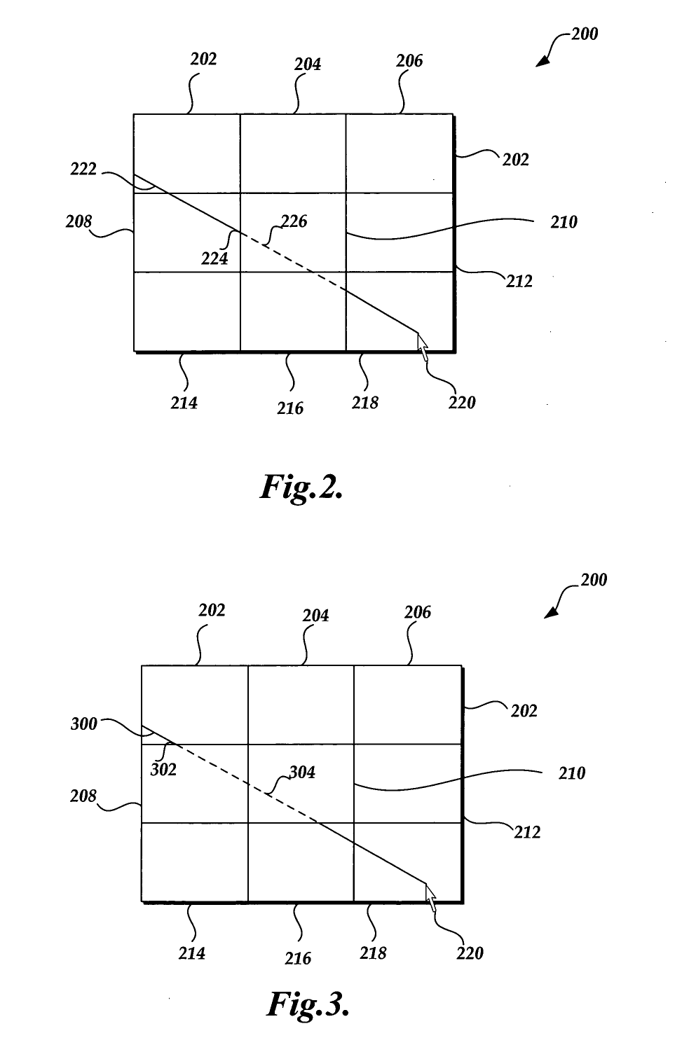

For illustrative purposes, a representative section of computer display 200 that may be used to illustrate aspects of the present invention is depicted in FIG. 2. As known to those skilled in the art and others, a computer display is composed of pixels, which are the basic units used to represent images. Pixels are so small and numerous that, collectively, they appear to merge into a single smooth image. In any event, FIG. 2 illustrates a highly magnified section of computer display 200 that includes pixels 202, 204, 206, 208, 210, 212, 214, 216, and 218. In addition, the computer display 200 includes a pointer 220 and a path 222 that represents pointer 220 movement. As shown in FIG. 2, an input device (e.g., input device 110) is used to relocate the pointer 220 across pixels 202, 208, 204, 210, 216, and 218, respectively. However, in this example, pixels 204, 210, and 216 are designated as a vertical adjustment barrier so that aspects of the present invention alter the location where the pointer 220 is displayed in the event that the adjustment barrier is intersected. More specific to FIG. 2, when the pointer 220 intersects pixel 210 at the point of intersection 224, the pointer 220 continues to be displayed at the adjustment barrier even though input is being generated that would normally cause the pointer 220 to move across pixel 210. For example, an exemplary projected path 226, represented with a dashed line in FIG. 2, identifies the location where the pointer 220 would normally be displayed given the input device movement that is being generated.

Generally described, when the pointer 220 intersects an adjustment barrier, a user may cause one of among several actions to be performed. For example, a user may (1) cause an input device selection event to occur; (2) generate input device movement that reverses the direction of the pointer back to an area of the computer display 200 where the adjustment barrier was intersected; or (3) generate input device movement that causes the pointer to pass through an area of the computer display 200 where pointer movement is adjusted. In instances when an input device selection event occurs, a command is input into the computer that is satisfied by existing systems. Moreover, if input device movement is generated that returns the pointer to an area of the computer display 200 where the adjustment barrier was intersected, the correlation between pointer and input device movement returns to normal unaffected by aspects of the present invention.

In instances when the user generates input device movement that causes the pointer to pass through a location where pointer movement is adjusted, aspects of the present invention cause the pointer to “jump” to the pointer's projected location. In the context of FIG. 2, the location on the computer display 200 where pointer movement is adjusted consists of pixels 204, 210, and 216. Thus, when the projected path 226 of the pointer moves beyond these pixels, aspects of the present invention cause the pointer to “jump” from the location on the adjustment barrier where the pointer is displayed to an area of the computer display were pointer movement is not adjusted (e.g., pixel 220).

From the user's perspective, when the pointer intersects a location where pointer movement is adjusted by aspects of the present invention, a temporary disconnection occurs between input device movement and pointer movement. The temporary disconnection allows the user to maintain acquisition of a target. However, if the user does not want to maintain acquisition of the target, the temporary disconnection between pointer and input device movement may be easily overcome. For example, when the projected movement of the pointer proceeds a predetermined threshold distance beyond an adjustment barrier, the pointer rapidly moves from the location where the pointer is currently being displayed. Thus, an adjustment barrier serves as an acquisition aid that does not enlarge the motor space of a target. As a result, in one embodiment, a user of a computer that employs a direct input device may easily acquire a target without causing a persistent disconnection between input device and pointer movement.

Now with reference to FIG. 3, an exemplary aspect of the present invention will be described in which pointer movement is adjusted when multiple adjustment barriers are intersected. For illustrative purposes, the same representative section of computer display 200 depicted in FIG. 2 is shown in FIG. 3. However, in this example, in addition to a vertical adjustment barrier comprising pixels 204, 210, and 216, a horizontal adjustment barrier exists that comprises pixels 208, 210, and 212. As shown in FIG. 3, an input device (e.g., input device 110) is used to relocate the pointer 220 along the path 300 across pixels 202, 208, 210, 216, and 218, respectively. However, in this example, since pixel 208 is designated as part of a horizontal adjustment barrier, pointer movement is adjusted when pixel 208 is intersected. Similar to the description provided above with reference to FIG. 2, when the pointer 220 intersects pixel 208, the pointer 220 continues to be displayed on the adjustment barrier intersected even though input is being generated that would normally cause the pointer 220 to continue moving. For example, an exemplary projected path 304 identifies the location where the pointer 220 would normally be displayed with a dashed line given the input device movement that is being generated.

As mentioned previously, the computer display 200 illustrated in FIG. 3 contains two adjustment barriers: namely a vertical adjustment barrier comprising pixels 204, 210, and 216, and a horizontal adjustment barrier comprising pixels 208, 210, and 212. Similar to the description provided above with reference to FIG. 2, when the pointer 220 intersects an adjustment barrier, pointer movement is adjusted so that a temporary disconnection occurs between where the pointer 220 is displayed and the path 300 of the pointer 220. In the example illustrated in FIG. 3, when the pointer 220 intersects the horizontal adjustment barrier at the point of intersection 302, the pointer 220 is displayed at the horizontal adjustment barrier until the projected movement of the pointer 220 moves completely through the location affected by the horizontal adjustment barrier. Stated differently, in this embodiment, the path 300 of the pointer 220 does not need to move completely through the predetermined distances where pointer movement is affected by the horizontal and vertical adjustment barriers to “break free” from the adjustment barriers. However, in alternative embodiments, the path 300 of the pointer 220 may be required to proceed through all of the adjustment barriers that are intersected before the pointer “breaks free.”

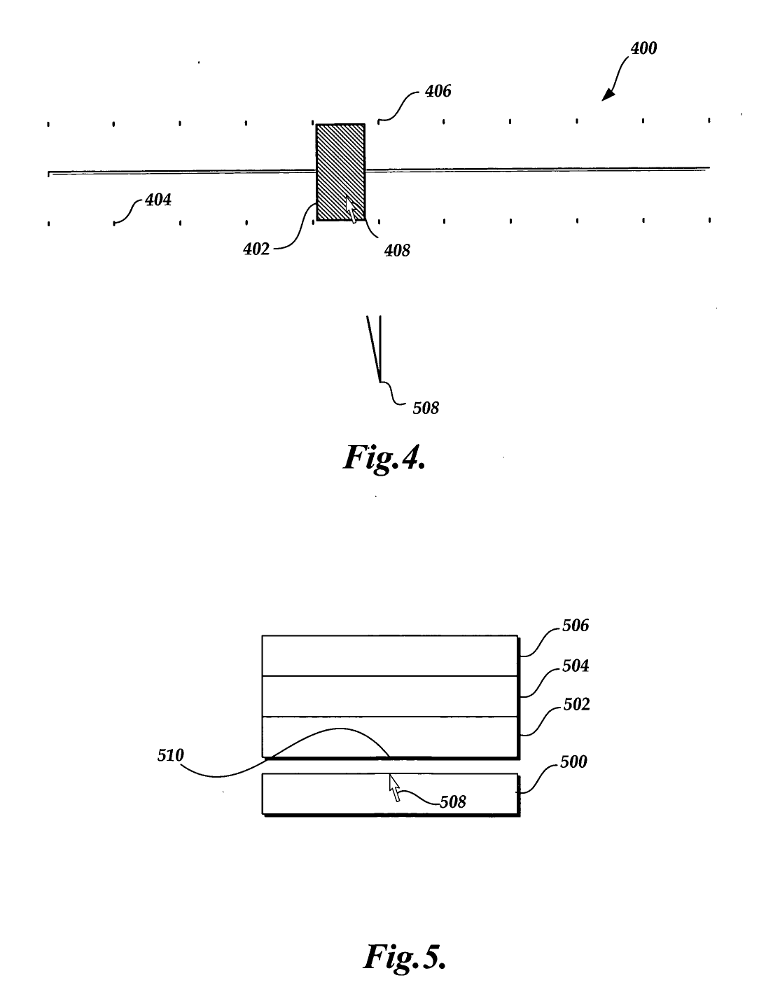

With reference now to FIGS. 4 and 5, exemplary applications of the present invention will be described. For the sake of convenience, much of the description below is provided in the context of using a pointer to select and align specific GUI objects using a technique commonly referred to as “drag-and-drop.” However, it should be well understood that the present invention is applicable in other contexts than those described. For example, those skilled in the art and others will recognize that aspects of the present invention may be implemented in various contexts when the pointer is not aligning GUI objects. In this regard, the present invention may be implemented in the context of acquiring and maintaining acquisition of small targets with a pointer. Thus, the examples provided with reference to FIGS. 4 and 5 below are illustrative and should not be construed as limiting.

Now with reference to FIG. 4 an exemplary application of the present invention in a one-dimensional context will be described. FIG. 4 includes a mechanism implemented by many computer programs commonly referred to as a slider 400. The slider 400 comprises more than one GUI object including a control button 402, a scale 404, and one or more scale indicators including scale indicator 406. As those skilled in the art will recognize, the slider 400 is operated by allowing the user to select the control button 402 with the pointer 408 and “dragging” the control button 402 along the scale 404. Typically, a slider 400 controls the value of a variable, such as the volume level of sound played by speakers connected to a personal computer. However, users may not be able to easily position the control button 402 that is being “dragged” at a value represented by a scale indicator, such as scale indicator 406.

In order to assist users in aligning the control button 402 at the value represented by the scale indicator 406, movement of the pointer 408 may be adjusted by aspects of the present invention. For example, the value on the slider 400 represented by the scale indicator 406 may be designated as an adjustment barrier. As a result, when the control button 402 is “dragged” across this adjustment barrier with the pointer 408, the control button 402 continues to be displayed at the value represented by the scale indicator 406 even though input may be generated that would normally cause the control button 402 to continue moving along the slider 400. Designating a location as an adjustment barrier allows users to easily position the control button 402 at a specified value on the slider 400. However, if the user generates input device movement that would normally cause the control button 402 to move beyond a predetermined distance from the adjustment barrier, aspects of the present invention allow the control button 402 to “break free” from the adjustment barrier and be displayed at a location beyond the adjustment barrier.

Now with reference to FIG. 5 an exemplary application of the present invention in a two-dimensional context will be described. More specifically, FIG. 5 illustrates an activity that is regularly performed in certain application programs. In this regard, FIG. 5 illustrates a GUI object 500 that is located below a three-level stack of other GUI objects 502, 504, and 506, respectively. As those skilled in the art will recognize, the pointer 508 is used to select the GUI object 500 and “drag” the GUI object 500 to an aligned coordinate position with the previously stacked GUI objects 502, 504, and 506. However, a user may not be able to easily position the GUI object 500 that is being “dragged” at an aligned coordinate position.

In order to assist users in aligning the GUI object 500 below the previously stacked GUI objects 502, 504, and 506, movement of the pointer 508 may be altered by aspects of the present invention. For example, the connection point 510 may be designated as a location that maintains both a vertical and horizontal adjustment barriers. As a result, when the GUI object 500 is “dragged” into an aligned coordinate position, a temporary disconnection occurs between input device and pointer movement. The temporary disconnection allows the user to keep the GUI object 500 located at an aligned coordinate position.

While specific applications of the present invention have been described with reference to FIGS. 4 and 5, those skilled in the art and others will recognize that the concepts described above are applicable in other contexts.

Now with reference to FIG. 6, a flow diagram that illustrates one exemplary embodiment of the adjustment routine 106 that is also depicted in FIG. 1 will be described. Those skilled in the art and others will recognize that each input device movement event may be divided into component directions that describes the movement of the input device. For example, an input device movement event may be broken into a horizontal component and a vertical component. As a preliminary matter, it should be well understood that the adjustment routine 106, as described below, is used to adjust pointer movement in one component direction at a time. However, as mentioned previously with reference to FIG. 3, a need may exist to adjust pointer movement in multiple component directions. In this regard, in accordance with one embodiment of the present invention, the adjustment routine 106 is executed twice in a two-dimensional environment for each input device movement event that is identified so that pointer movement may be adjusted in two component directions (e.g. the vertical and horizontal component directions that exist on a two-dimensional computer display). However, those skilled in the art and others will recognize that the adjustment routine 106 could be applied in other environments such as a three-dimensional environment, as well. Thus, the examples provided herein should be considered as exemplary and not limiting. Now, with continuing reference to FIGS. 1-5 and the accompanying descriptions, an exemplary adjustment routine 106 illustrated in FIG. 6 will now be described.

As illustrated in FIG. 6, the adjustment routine 106 begins at block 600 where an input device movement event is identified. For example, the input device 110 (FIG. 1) may generate an input device movement event that is identified by the operating system 104 when the input device 110 is moved by a user. As mentioned previously, existing systems allow event-driven routines to be notified and receive data related to an input device movement event. In this regard, an operating system (e.g., the operating system 104) may be configured to communicate data that contains the current and projected locations on the computer display where the pointer would normally be displayed as a result of the input device movement event. Thus, at block 600, the adjustment routine 106 may receive data that describes the movement of the input device and how the pointer would normally be displayed absent the adjustments to pointer movement that are performed by aspects of the present invention.

At decision block 601, the adjustment routine 106 determines whether a GUI object is currently selected so that the GUI object is being “dragged” by the pointer. As mentioned previously, users frequently align GUI objects by implementing a “click and drag” technique where a single pointer event such as a button click selects the GUI object. Once the GUI object is selected, the pointer moves the GUI object to a new location where a second pointer event places the GUI object. In any event, aspects of the present invention may be used either when the pointer is “dragging” a GUI object or in instances when a GUI object is not selected. Since each GUI object has characteristics that determine whether the GUI object is at an aligned coordinate position in relation to an adjustment barrier, identifying when a pointer is located so that a GUI object is at an aligned coordinate position varies depending on the characteristics of the GUI object. Also, determining whether the GUI object is at an aligned coordinate position depends on the pointer's position on the selected GUI object. Thus, a current and projected position of the pointer that accounts for an appropriate offset is calculated when a GUI object is selected. A current and projected position of the pointer that accounts for an appropriate offset allows the adjustment routine 106 to determine whether a GUI object is placed at an aligned coordinate position in relation to an adjustment barrier. In any event, if a GUI object is currently selected, the adjustment routine 106 proceeds to block 602. Conversely, if a GUI object is not currently selected, the adjustment routine 106 proceeds to block 603, described in further detail below.

At block 602, a current and projected location of the pointer that accounts for an appropriate offset is calculated. If block 602 is reached, a GUI object is currently selected by the pointer. As described in further detail below, when a GUI object is not selected, a projected path of the pointer is identified by aspects of the adjustment routine 106 based on the current and projected position of the pointer that was received from the operating system at block 600. However, when a GUI object is selected, an adjusted path of the pointer is identified based on an adjusted current and projected location of the pointer that accounts for an appropriate offset caused by the selection of the GUI object.

At block 603, the projected path that the pointer is scheduled to be moved on the computer display is identified. In instances when a GUI object is not currently selected, the current and projected coordinate positions where the “hot spot” of the pointer is displayed before and after the input device movement event generated at block 600 are used to identify the projected path of the pointer, at block 603. As mentioned previously with reference to block 600, an operating system may be configured to communicate data to the adjustment routine 106 when an input device movement event occurs. In instances when a GUI object is selected, the current and projected coordinate positions of the pointer that accounts for the selected GUI object, calculated at block 602, is used to identify the projected path of the pointer.

As illustrated in FIG. 6, at decision block 604, the adjustment routine 106 determines whether the input device movement event identified at block 600 would cause the pointer to intersect an adjustment barrier. In accordance with one embodiment of the present invention, an interface is provided that allows computer programs, such as application 108, to create instances of adjustment barriers. Thus, the location of all adjustment barriers on a computer display is known and tracked by aspects of the present invention. Once the location of the adjustment barriers and current and projected location of the pointer are known, determining whether the projected path of the pointer insects an adjustment barrier may be performed, at block 604, using techniques that are generally known in the art. If the projected pointer movement does not intersect an adjustment barrier, the routine 106 proceeds to block 608 described below. Conversely, if the projected path of the pointer is scheduled to intersect one or more adjustment barriers, the adjustment routine 106 proceeds to block 606.

At block 606, the pointer is “marked” as scheduled to be displayed on the adjustment barrier that was intersected last. Aspects of the present invention maintain a data item that identifies whether a pointer movement is currently being adjusted as a result of intersecting an adjustment barrier or, conversely, whether the pointer is being displayed at a location that corresponds to the input generated by the input device. If block 606 is reached, the pointer is scheduled to intersect one or more adjustment barriers. In this instance, at block 606, the adjustment routine 106 sets the value of this data item to reflect that the pointer will intersect a barrier and is currently scheduled to be displayed on the barrier. If the pointer will only intersect one adjustment barrier, then the pointer is “marked” as scheduled to be displayed on the only adjustment barrier that will be intersected. On the other hand, if the pointer will intersect multiple adjustment barriers, than the data item is set to indicate that the pointer is currently scheduled to be displayed on the adjustment barrier that was intersected last.

At block 608, the adjustment routine 106 determines whether the input device movement event identified at block 600 would cause the projected movement of the pointer to re-intersect a previously intersected adjustment barrier. If block 608 is reached, the pointer may be displayed at an adjusted coordinate position that is on an adjustment barrier. In this instance, the user may cause one of a number of different actions to occur. For example, the user may (1) generate an input device selection event; (2) generate input device movement that reverses the direction of the pointer back to an area of the computer display where the adjustment barrier was intersected; or (3) generate input device movement that causes the pointer to pass through a threshold distance of the computer display where pointer movement is adjusted. In instances when the user generates an input device movement event that does not affect pointer movement (i.e., a pointer selection event), previously realized systems handle the event. However, in instances when a input device movement event is identified (at block 600), the adjustment routine 106 makes a determination, at block 608, regarding whether the event causes a pointer to re-intersect a previously intersected adjustment barrier.

In accordance with one aspect of the present invention, a data item is associated with each adjustment barrier that identifies the direction on the computer display in which the adjustment barrier is adjusting pointer movement. In this regard, an adjustment barrier will cause pointer movement to be adjusted in a direction that is opposite of the component direction in which the pointer intersected the adjustment barrier. For example, in the context of FIG. 2, when the pointer is being moved from left to right across a computer display and a vertical adjustment barrier is intersected, pointer movement is adjusted in the horizontal direction toward the left side of the computer display. In this instance, a data item maintained by aspects of the present invention indicates that pointer movement is being adjusted in this way. At block 608, the adjustment routine 106 determines whether the input device movement event identified at block 600 would cause the projected movement of the pointer to re-intersect an adjustment barrier. More specifically, in one embodiment, the data item that identifies the direction in which pointer movement is being adjusted is accessed and compared to the projected location of the pointer. If the projected location of the pointer is on the side of an adjustment barrier where pointer movement is adjusted, then the pointer is not projected to re-intersect the adjustment barrier and the adjustment routine 106 proceeds to block 610, described below. Conversely, if the projected location of the pointer is on the side of the adjustment barrier where pointer movement is not being adjusted, then the pointer is projected to re-intersect the adjustment barrier and the adjustment routine 106 proceeds to block 612.

At decision block 610, the adjustment routine 106 determines whether the pointer is currently “marked” as having intersected an adjustment barrier. As mentioned briefly above, the value of one or more data items may be set when the pointer is scheduled to intersect or has previously intersected an adjustment barrier as a result of a pointer movement event. For example, a data item is set or “marked,” at block 606, to indicate that the pointer is scheduled to intersect one ore more adjustment barriers as a result of a pointer movement event. In this instance when the pointer is scheduled to intersect one or more adjustment barriers or is currently being displayed on an adjustment barrier, the adjustment routine 106 proceeds to block 612. Conversely, if the value of the variable indicates that the location of the pointer is not being affected by an adjustment barrier, the adjustment routine 106 proceeds to block 616, described in further detail below.

As illustrated in FIG. 6, at decision block 612, the adjustment routine 106 determines whether the projected location of the pointer will remain inside the threshold distance from an intersected adjustment barrier that may be affecting pointer movement. If block 612 is reached, pointer movement may be affected by an adjustment barrier. In this instance, the adjustment routine 106 performs a test, at block 612, to determine whether the projected location of the pointer will remain inside the threshold distance away from the adjustment barrier. In making this determination, the distance between the projected location of the pointer that was obtained from the operating system at block 600 is compared to the threshold distance that is associated with the adjustment barrier that was most recently intersected. If the distance between the appropriate adjustment barrier and the projected location of the pointer is greater than the threshold distance, a determination is made that the pointer will not remain inside the threshold distance from the adjustment barrier and the routine 106 proceeds to block 616, described in further detail below. Conversely, if the projected location of the pointer is inside the threshold distance from the most recently intersected adjustment barrier, the routine 106 proceeds to block 614.

At block 614, the location where the pointer is scheduled to be displayed is set to equal the location of the adjustment barrier that was most recently intersected. If block 614 is reached, the pointer is “marked” as having intersected an adjustment barrier. Moreover, the input device movement event identified at block 600 will not cause the projected location of the pointer to either (1) move beyond the threshold distance from the adjustment barrier that was intersected last, or (2) to re-intersect an adjustment barrier where the pointer is currently being displayed. As a result, pointer movement will be adjusted by aspects of the present invention so that the pointer will be displayed on an adjustment barrier even though input device movement may have been generated that would normally cause the pointer to be displayed at a location that is beyond the adjustment barrier. In either instance, the location where the pointer will be displayed, in at least one component direction, is dictated by an adjustment barrier that was most recently intersected. As described previously with reference to FIGS. 2-3, an operating system is typically responsible for causing a pointer to be displayed on the computer display. Thus, in one embodiment, the adjustment routine 106 is configured to communicate the location (e.g., coordinate position in one component direction) on the computer display where the pointer will be displayed at block 614. Then, the adjustment routine 106 proceeds to block 620 where it terminates.

At block 616, the pointer is “marked” as being displayed at a position that corresponds to input received from an input device. As mentioned previously, aspects of the present invention maintain a data item that identifies whether a disconnection currently exists between input device movement and pointer movement. At block 616, the adjustment routine 106 sets the value of this data item to reflect that a disconnection does not currently exist in the location where the pointer will be displayed is dictated by the input device. Then, at block 618, the location where the pointer will be displayed is set to equal the projected location of the pointer that is dictated by an input device. If block 618 is reached, pointer movement will not be affected by an adjustment barrier. For example, an input device movement event may be identified that does not cause the pointer to intersect an adjustment barrier. Alternatively, the pointer may intersect one or more adjustment barriers and have a projected location that is beyond the threshold distance from the last adjustment barrier intersected. In either instance, the location where the pointer will be displayed, in at least one component direction, is dictated by the input device. As described previously with reference to FIGS. 2-3, an operating system is typically responsible for causing a pointer to be displayed on the computer display. Thus, in one embodiment, the adjustment routine 106 is configured to communicate the location (e.g., coordinate position in one component direction) on the computer display where the pointer will be displayed at block 618, which corresponds to the projected location of the pointer as dictated by the input device. Then, the adjustment routine 106 proceeds to block 620 where it terminates.

As mentioned previously, in accordance with one embodiment of the present invention, the adjustment routine 106 is executed twice in a two-dimensional environment for each input device movement event that occurs so that pointer movement may be adjusted in both the vertical and horizontal component directions that exist on a computer display. In some instances, the adjustment routine 106 may cause pointer movement to be adjusted in one component direction whereas, in another component direction, the location of the pointer is dictated by the input device. For example, the pointer may intersect a vertical adjustment barrier so that pointer movement is adjusted in the horizontal component direction. However, while the location of the pointer in the horizontal component direction is set to the adjustment barrier, in the vertical component direction the location of the pointer may be dictated by the input device in the vertical component direction. From a user's perspective, when the vertical adjustment barrier is intersected, the pointer is allowed to “slide” in the vertical component direction in accordance with input received from the input device.

While illustrative embodiments have been illustrated and described, it will be appreciated that various changes can be made therein without departing from the spirit and scope of the invention.

1. In a computer that includes a display for displaying a target and a pointer, and a input device for generating events for moving the pointer, a method of facilitating the acquisition of the target with the pointer, the method comprising:
(a) in response to an input device movement event:
(i) determining whether the projected movement of the pointer intersects an adjustment barrier associated with the target;
(ii) if the projected movement of the pointer intersects the adjustment barrier, causing the pointer to be displayed on the adjustment barrier;
(b) while the projected movement of the pointer is within a threshold distance of the adjustment barrier, causing the pointer to be displayed on the adjustment barrier; and
(c) if the projected movement of the pointer is beyond the threshold distance from the adjustment barrier, causing the pointer to move to the projected location.

2. The method as recited in claim 1, further comprising implementing a data item that tracks whether the coordinate position of the pointer in one component direction is dictated by the location of the adjustment barrier or the input received from an input device.

3. The method as recited in claim 2, further comprising:
(a) setting the value of the data item to indicate that the coordinate position of the pointer is dictated by input received from the input device if the projected location of the pointer from the adjustment barrier is greater than the threshold distance; and
(b) communicating to an operating system installed on the computer that the pointer will be displayed at the location that represents the input received from the input device.

4. The method as recited in claim 2, further comprising:
(a) setting the value of the data item to indicate that the coordinate position of the pointer is dictated by input received from the input device if the projected movement of the pointer proceeds back through the adjustment barrier; and
(b) communicating to an operating system installed on the computer that the pointer will be displayed at the location that represents the input received from the input device.

5. The method as recited in claim 1, further comprising if the projected movement of the pointer is beyond the predetermined distance from the adjustment barrier, allowing the pointer to be displayed at the projected location that represents the input received from the input device.

6. The method as recited in claim 1, further comprising if the projected movement of the pointer proceeds back through the adjustment barrier, allowing the pointer to be displayed at the projected location that represents input received from the input device.

7. The method as recited in claim 1, wherein determining whether the projected movement of the pointer intersects an adjustment barrier includes:
(a) obtaining the current and projected coordinate positions of the pointer from an operating system
(b) determining whether a GUI object is currently selected; and
(c) if a GUI object is currently selected, using a current and projected position of the pointer that accounts for an offset to identify the projected path the pointer.

8. The method of claim 1, wherein determining whether the projected movement of the pointer intersects an adjustment barrier includes:
(a) identifying the location on the display of the computer occupied by the adjustment barrier; and
(b) comparing the location of the adjustment barrier with the current and projected coordinate positions of the pointer.

9. The method as recited in claim 7, wherein obtaining the current and projected coordinate positions of the pointer includes:
(a) if the value of a data item indicates that the position of the pointer is dictated by the location of the adjustment barrier, determining that the current position of the pointer is the same as the location of the adjustment barrier; and
(b) conversely, if the value of a data item indicates that the position of the pointer is not dictated by the location of the adjustment barrier, determining that the current position of the pointer is dictated by input generated by the input device.

10. The method as recited in claim 1, wherein the adjustment barrier is located at the boundary of the target; and
wherein the threshold distance is equal to the distance on the display in one component direction that is occupied by the target.

11. The method of claim 1, wherein the display is a touch sensitive display and a pointer input device relocates the pointer through direct contact with the touch sensitive display.

12. The method of claim 1, wherein facilitating the acquisition of the target is performed without enlarging the motor space that is allocated to the target; and
wherein facilitating the acquisition of the target is performed without inhibiting the pointer from being displayed at any location on the display.

13. A software system for assisting a user acquire a target displayed on a display with a pointer, the system comprising:
(a) an operating system that manages access to the hardware resources of a computer and input obtained from a user including input generated with a pointer input device;
(b) a graphical user interface operative to display graphical objects on the display including the target and the pointer; and
(c) an adjustment routine operative to adjust the location where the pointer is displayed on the display when the projected movement of the pointer intersects an adjustment barrier associated with the target.

14. The software system as recited in claim 13, further comprising an application program operative to instantiate an adjustment barrier to facilitate the acquisition of the target with the pointer.

15. The software system as recited in claim 13, wherein the adjustment routine is further configured to cause the pointer to be displayed on the adjustment barrier when the projected movement of the pointer intersects the adjustment barrier.

16. The software system as recited in claim 13, wherein the adjustment routine is further configured to allow the pointer to move a graphical user interface object into an aligned coordinate position with the target.

17. A computer-readable medium containing computer-readable instructions which, when executed in a computer that includes a display for displaying a target and a pointer, and a input device for generating events for moving the pointer, performs a method of facilitating the acquisition of the target with the pointer, the method comprising:
(a) in response to an input device movement event:
(i) determining whether the projected movement of the pointer intersects an adjustment barrier associated with the target;
(ii) if the projected movement of the pointer intersects the adjustment barrier, causing the pointer to be displayed on the adjustment barrier; and
(b) while the projected movement of the pointer is within a threshold distance of the adjustment barrier, causing the pointer to be displayed on the adjustment barrier.

18. The computer-readable medium as recited in claim 17, wherein if the pointer intersects the adjustment barrier and input device movement is generated that causes the projected path of the pointer to move a predetermined distance beyond the adjustment barrier, allowing the pointer to be displayed at a location that is the predetermined distance away from the adjustment barrier.

19. The computer-readable medium as recited in claim 17, wherein determining whether the projected movement of the pointer intersects an adjustment barrier includes:
(a) obtaining the current and projected coordinate positions of the pointer;
(b) identifying the location on the display of the computer occupied by the adjustment barrier; and
(c) comparing the location occupied by the adjustment barrier with the current and projected coordinate positions of the pointer.

20. The computer-readable medium as recited in claim 17, wherein the adjustment barrier may be instantiated by an application programs installed on the computer.
